(19) United States
(12) Patent Application Publication
(10) Pub. No.: US 2010/0283467 A1
(43) Pub. Date: Nov. 11, 2010

(54) METAL DETECTOR WITH IMPROVED MAGNETIC RESPONSE APPLICATION

(75) Inventor: Bruce Halcro Candy, Basket Range (AU)

Correspondence Address: Beyer Law Group LLP, P.O. BOX 1687, Cupertino, CA, 95015-1687, US

(73) Assignee: MINELAB ELECTRONICS PTY LIMITED, Torrensville, South Australia (AU)

(21) Appl. No.: 12/742,422

(22) PCT Filed: Nov. 11, 2008
(86) PCT No.: PCT/AU2008/001667

§ 371 Date: Jul. 20, 2010

(30) Foreign Application Priority Data
Nov. 12, 2007 (AU) 2007906175

(51) Int. Cl. G01V 3/08

(52) U.S. Cl. 324/326

(57) ABSTRACT

This invention discloses a low cost metal detector which suppresses signals arising from signals induced in a receive inductor from a rate of change of environmental static fields. The metal detector processes a signal due to a rate of change of environmental static fields to produce a first signal, and processes a signal due to the transmitted magnetic field to produce a second signal, the second signal includes a proportion of the first signal. Signal processing includes the subtraction of an estimation of the proportion of the first signal from the second signal to produce a third signal, such that the third signal is substantially independent of the first signal; and the receive electronics further processes the third signal to produce an indicator output signal, the indicator output signal includes a signal indicative of the presence of a metallic target and is substantially unaffected by the signal due to a rate of change of environmental static fields.

### TECHNICAL FIELD

This invention relates to metal detectors that are generally time-domain detectors, with pre-demodulation or sampling broadband bandwidths that include direct current (DC) components or at least include very low frequency components.

### BACKGROUND OF THE INVENTION

The general forms of most metal detectors that interrogate soils are either hand-held battery operated units, conveyor-mounted units, or vehicle-mounted units. Examples of hand-held units include detectors used to locate gold, explosive land mines or ordnance, and coins and treasure. An example of a conveyor-mounted unit includes fine gold detectors in ore mining operations. An example of a vehicle-mounted unit includes a unit to search for land mines.

An electronic metal detector includes at least one or more inductors which transmit and receive a magnetic field, and such inductors are often referred to as the coil of the metal detector. The transmit electronics of the metal detector generates a repeating signal cycle (called a repeating transmit signal cycle) that is applied to the coil to produce a transmitted magnetic field. At least one inductor is used to receive a magnetic field to produce a received signal (an electro motive force (emf) signal), the inductor being connected to receive electronics which may amplify and filter the received signal. The received signal is further processed by the receive electronics to produce an output indicator signal.

Some metal detectors are referred to as “time-domain” detectors. Examples of such detectors are described in U.S. Pat. No. 5,576,624, U.S. Pat. No. 6,636,044, U.S. Pat. No. 6,653,838, U.S. Pat. No. 5,537,041, WO 2005/047932 and Australian application 2006903737. The term “time-domain” usually implies that the pre-synchronous demodulation or sampling broadband bandwidths include DC components or at least include very low frequencies as understood by a person skilled in the art. The problem with this art is that the demodulation process is never perfect and the attenuation of the DC components or very low frequencies arising from a received signal related to a signal induced in the receive coil from a rate of change of environmental static fields is not perfect, thus causing spurious output signals related to this signal source, especially when the synchronous demodulation or sampling reference signals are changed when for example, a metal detector selects different signals to change the detection sensitivity profile. Such environmental static fields include the Earth's magnetic field and the fields of magnetised rocks that are in the vicinity of the coil.

Many commercial time-domain metal detectors (such as pulse induction units) include, in their synchronous demodulation or sampling process, preset potentiometers to fine adjust to cancel out very low frequency signals (e.g. DC to 10 Hz; the bandwidth of typical post synchronous demodulation or sampling low pass filters) prior to the synchronous demodulation or sampling. A post synchronous demodulation signal or a post sampling process signal (which may also include filtering), a second signal, is thus free of the very low frequency signals. These preset potentiometers including the setting of these on a factory production line is relatively expensive.

Worse, if the synchronous demodulation or sampling reference signals are changed, then owing to electronics component variability, the setting of the potentiometers needs to be altered, albeit slightly. The only way to guarantee the same accurate suppression of the very low frequency signals performance for different synchronous demodulation or sampling reference signals is to have a different set of potentiometers for each set of different signals. This is even more expensive.

Thus, there is a need for a low cost invention to accurately suppress/cancel signals arising from signals induced in a receive inductor from a rate of change of environmental static fields.

The simpler and cheaper method described herein is to measure the very low frequency signals to give a first signal, estimate the amount of this first signal component in a second signal for each different synchronous demodulation or sampling reference waveforms, then subtract a proportion of the first signal from the second signal so as to substantially cancel the first signal component in the second signal. This process may be repeated for each different set of synchronous demodulation or sampling reference signals. All of this may be achieved at low cost in software with coefficients of the proportion of the first signal selected or determined, when each different set of synchronous demodulation or sampling reference waveforms is selected. The set of coefficients may be programmed into each detector automatically on a production line. Alternatively, the coefficients may be determined automatically using negative feedback or feed-forward nulling systems. For example, the input to the negative feedback amplifier may be the second signal multiplied or divided (with appropriate limits) by the first signal etc. relative to zero. The response of the second and first signals' filters must be time-aligned.

Further, if the metal detector is to be used in mineralised soils, the advantage may be gained if the synchronous demodulation or sampling process, that is substantially imbalanced to asynchronous signals in the receive signal, is approximately independent of signal components from magnetised soil materials with magnetically permeable resistive components independent of frequency at least up to 100 kHz, under the influence of the alternating magnetic field. This arrangement results in the selected proportions of the first signal required to cancel any first signal components in the second signal being insensitive to signals from the mineralised soils, except for rates of change of static magnetic fields that cause very low frequency components in at least one inductor of the coil.

### SUMMARY OF THE INVENTION

According to an aspect of the present invention, there is provided a metal detector including: a) transmit electronics for generating a repeating transmit signal cycle; b) a transmit coil connected to the transmit electronics for receiving the repeating transmit signal cycle and generating a transmitted magnetic field for transmission; c) a receive coil for receiving a received magnetic field and providing a received signal induced by the received magnetic field including a signal due to a rate of change of environmental static fields and a signal due to the transmitted magnetic field; and d) receive electronics connected to the receive coil for processing the received signal, wherein the receive electronics processes the received signal to produce a first signal and a second signal, wherein the first signal is more dependent upon the signal due to the rate of change of environmental static fields applied to the receive coil than is the second signal, and the second signal includes a proportion of the first signal; the receive electronics further subtracts a signal proportional to the first signal from the second signal to produce a third signal, such that the third signal is substantially independent of the first signal; and the receive electronics further processes the third signal to produce an indicator output signal, the indicator output signal including a signal indicative of the presence of a metallic target and is substantially unaffected by the signal due to a rate of change of environmental static fields.

In one form, the transmit coil and the receive coil are the same coil.

In one form, the signal proportional to the first signal is produced through a multiplication of the first signal by a coefficient.

In one form, the coefficient is determined by a feed-forward nulling system within the receive electronics.

In one form, the second signal is divided by a first signal to produce a quotient, the quotient is further processed by the receive electronics including averaging to produce the coefficient.

In one form, the coefficient is determined by a negative feedback loop within the receive electronics.

In one form, wherein the process of the receive electronics including a second synchronous demodulation or sampling of the received signal, the second synchronous demodulation or sampling producing the second signal, is substantially balanced to asynchronous signals in the receive signal.

In one form, the processing of the received signal including a second synchronous demodulation or sampling of the received signal is substantially balanced to asynchronous signals in the received signal to produce the second signal.

In one form, the process of the receive electronics including a first synchronous demodulation or sampling of the received signal, the first synchronous demodulation or sampling producing the first signal, is substantially imbalanced to asynchronous signals in the receive signal.

In one form, the process of the receive electronics including a first synchronous demodulation or sampling of the received signal, the first synchronous demodulation or sampling producing the first signal, is substantially imbalanced to asynchronous signals in the receive signal.

In one form, the coefficient is selected from a list of pre-programmed coefficients when a reference signal is selected for the first and/or the second synchronous demodulation or sampling.

In one form, the processing of the received signal including a first synchronous demodulation or sampling of the received signal is substantially imbalanced to asynchronous signals in the received signal to produce the first signal.

In one form, the processing of the received signal including a first synchronous demodulation or sampling of the received signal is substantially imbalanced to asynchronous signals in the received signal to produce the first signal.

In one form, the coefficient is selected from a list of pre-programmed coefficients when a reference signal is selected for the first and/or the second synchronous demodulation or sampling.

In one form, the first signal is substantially independent of a signal due to magnetic soil materials with magnetically permeable resistive components independent of frequency at least up to 100 kHz.

In one form, an averaging of the received signal produces the said first signal.

In one form, the averaging is performed by a low-pass filter.

A detailed description of one or more embodiments of the invention is provided below along with accompanying figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications, and equivalents. For the purpose of example, numerous specific details are set forth in the following description in order to provide a thorough understanding of the present invention. The present invention may be practised according to the claims without some or all of these specific details. For the purpose of clarity, technical material that is known in the technical fields related to the invention has not been described in detail so that the present invention is not unnecessarily obscured.

The reference to any prior art in this specification is not, and should not be taken as, an acknowledgment or any form of suggestion that such prior art forms part of the common general knowledge of the technical field.

To assist with the understanding of this invention, reference will now be made to the drawings:

### BRIEF DESCRIPTION OF THE DRAWINGS

FIG. 1 shows a block electronic circuit diagram of one embodiment of the invention with an electronic system capable of producing both first, second and third signals, and an output indicator signal which is substantially unrelated to any signal related to the rate of change of environmental static fields applied to the first inductor; and

FIG. 2 shows a block electronic circuit diagram of another embodiment of the invention with an alternative to empirically selecting/determining the said coefficients as described below, the coefficients may be selected automatically by the use of a feed-forward nulling system.

FIG. 3 shows a block electronic circuit diagram of yet another embodiment of the invention with an alternative to empirically selecting/determining the said coefficients as described below, the coefficients may be selected automatically by the use of a negative feedback loop.

### DETAILED DESCRIPTION OF THE INVENTION

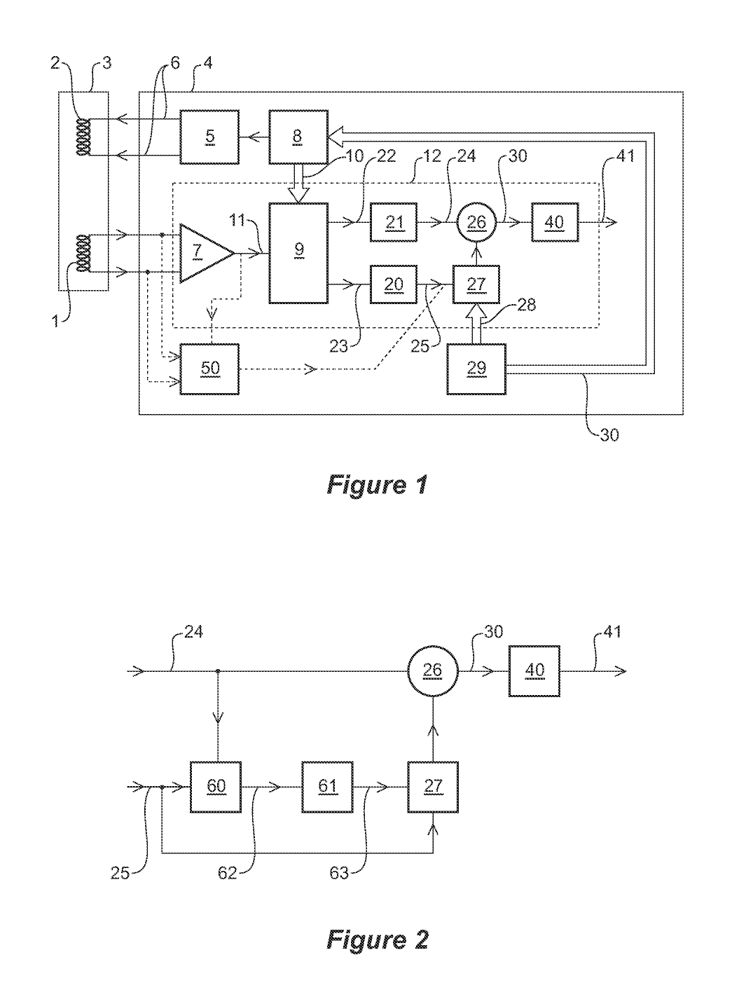

FIG. 1 shows a block diagram of one embodiment including electronics within a housing 4 and a coil arrangement 3 connected to the electronics. The coil arrangement 3 is usually spaced from the metal detector electronics housing 4. The coil arrangement 3 may contain one or more inductors to transmit and/or receive an alternating magnetic field.

In this embodiment, there are two inductors within the coil arrangement 3. One of these inductors, a first inductor 1, acts as a receive coil and is arranged and adapted to receive a received magnetic field to produce a received signal (an emf signal). A second inductor 2 acts as a transmit coil and is connected to transmit electronics 5 which is arranged and adapted to generate a repeating transmit signal cycle at 6 across the transmit coil (the second inductor 2) which results in a transmitted magnetic field. The transmit electronics 5 is controlled by timing electronics 8. The first inductor 1 is connected to receive electronics 12 at an amplifier 7 input, which is arranged and adapted to amplify, and may also filter, the received signal to produce an amplified signal at an output 11 of amplifier 7. The receive electronics 12 is arranged and adapted to contain additional signal processing devices which may process the amplified signal to produce an output indicator signal 41. During the additional processing, the amplified signal 11 is fed to inputs of sampling electronics or synchronous demodulating electronics 9 which samples or demodulates the amplified signal synchronously with the transmitted signal. Sampling reference signals to the sampling electronics or synchronous demodulating electronics 9 are provided by the timing electronics 8 via control lines 10. A first output 23 of the sampling electronics or synchronous demodulating electronics 9 is fed to first filtering electronics 20. A first signal 25 is produced at an output of the first filtering electronics 20. The synchronous demodulation or sampling electronics process that produces the first signal is substantially imbalanced to asynchronous signals in the received signal, for example signals induced in the first inductor 1 from a rate of change of environmental static fields applied to the first inductor 1.

The sampling electronics or synchronous demodulating electronics 9 may be in conventional analogue sampling form, or switch or mixer form, or digital signal processing (DSP) form including analogue to digital converters.

A second output 22 of the sampling electronics or synchronous demodulating electronics 9 is connected to a second filtering electronics 21. The synchronous demodulation or sampling process that produces the output 22 is approximately balanced to asynchronous signals in the received signal, for example a signal induced in the first inductor 1 from a rate of change of environmental static fields applied to the first inductor. An output of the second filtering electronics 21 produces a second signal 24. However, owing to imperfect electronics, the second signal 24 may contain a component equal to a proportion of the first signal 25. A coefficient (or a multiplication factor) approximating a proportion of the first signal 25 within the second signal 24 is selected/determined by control unit 29 and the first signal 25 is multiplied by the coefficient in a multiplier 27. A product signal at the output of the multiplier 27 is fed to a subtractor 26. The second signal at 24 is also fed to the subtractor 26. A difference signal at the output of the subtractor 26 produces a third signal 30, such that the third signal 30 is approximately independent of any component of the first signal 25. The third signal 30 is fed to further processing electronics 40 to produce the output indicator signal 41, which is substantially independent of any signal related to the rate of change of environmental static fields applied to the first inductor 1.

The control unit 29 also controls the timing electronics 8 via control lines 30 such that the repeating transmit signal cycle and the reference signals to the sampling electronics or synchronous demodulating electronics 9 may be altered. When the reference signals are altered, a new value for the coefficient is selected by the controls 29 for multiplier 27 via control lines 28.

The reference signals to the sampling electronics or synchronous demodulating electronics 9 may be selected so that the first signal 25 is substantially independent of signal components due to magnetic soil materials with magnetically permeable resistive components independent of frequency at least up to 100 kHz under the influence of the transmitted magnetic field, except for any static fields from these soils which may induce a received signal in the first inductor 1 from the rate of change of these static fields applied to the first inductor 1 due to the movement of the first inductor with respect to the static fields.

An alternative embodiment to generating the first signal 25 is to average either the received signal across the first inductor 1 or the amplified signal 11, for example a low-passed filtered signal. These alternatives are both shown in FIG. 1, with the received signal feeding a filter 50 or the amplified signal 11 feeding the filter 50. An output of the filter 50 replaces the output from the first filtering electronics 20 as the first signal 25 feeding the multiplier 27. The filtering transfer functions of the path including 7, 9, 21, the path including 7, 9, 20, and the path including 50 must be time aligned.

FIG. 2 depicts a feed-forward nulling system as discussed as an alternative automatic approach to determine the coefficient used by the multiplier 27. In FIG. 2, the roles of labels 24, 25, 26, 27, 30, 40 and 41 are the same as that in FIG. 1. The first signal 25 is fed to a divider 60 as a divisor and the second signal 24 is also fed to the divider 60 as a dividend. The division process may include limits (for example, the lower limit for the absolute value of the divisor). The output of the divider 60 is a quotient 62, which is fed to an averager 61, for example a low-pass filter. An averaged output 63 of the averager 61 is fed to the multiplier 27 and in effect is the coefficient for the multiplier 27 after the output of the averager 61 has stabilised.

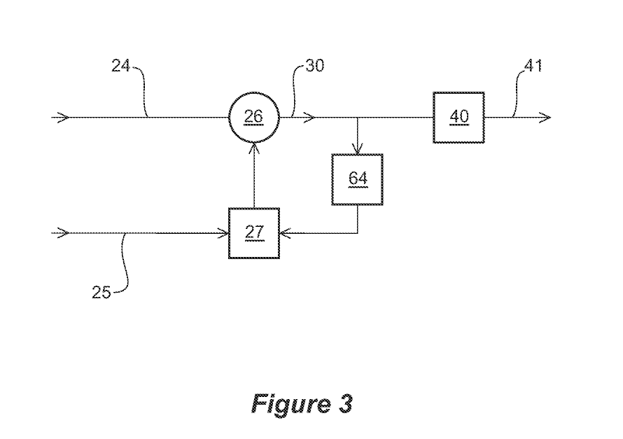

FIG. 3 depicts a negative feedback loop as discussed as an alternative automatic approach to determine the coefficient used by the multiplier 27. In FIG. 3, the roles of labels 24, 25, 26, 27, 30, 40 and 41 are the same as that in FIG. 1. An accumulator or integrator 64 forms together with the multiplier 27 and subtractor 27 a negative feedback loop. In particular, the output of the subtractor 27 is fed to the accumulator or integrator 64, and the output of the accumulator or integrator 64 is fed to the multiplier 27. The coefficient (multiplication factor) of the multiplier is adjusted/selected/determined based on the output of the accumulator or integrator 64.

1. A metal detector, comprising:
a) transmit electronics for generating a repeating transmit signal cycle;
b) a transmit coil connected to the transmit electronics for receiving the repeating transmit signal cycle and generating a transmitted magnetic field for transmission;
c) a receive coil for receiving a received magnetic field and providing a received signal induced by the received magnetic field including a signal due to a rate of change of environmental static fields and a signal due to the transmitted magnetic field; and
d) receive electronics connected to the receive coil for processing the received signal,
wherein the receive electronics processes the received signal to produce a first signal and a second signal, wherein the first signal is more dependent upon the signal due to the rate of change of environmental static fields applied to the receive coil than is the second signal, and the second signal includes a proportion of the first signal;
the receive electronics further subtracts a signal proportional to the first signal from the second signal to produce a third signal, such that the third signal is substantially independent of the first signal; and
the receive electronics further processes the third signal to produce an indicator output signal, the indicator output signal including a signal indicative of the presence of a metallic target and is substantially unaffected by the signal due to a rate of change of environmental static fields.

2. A metal detector according to claim 1, wherein the transmit coil and the receive coil are the same coil.

3. A metal detector according to claim 1, wherein the signal proportional to the first signal is produced through a multiplication of the first signal by a coefficient.

4. A metal detector according to claim 3, wherein the
coefficient is determined by a feed-forward nulling system within the receive electronics.

5. A metal detector according to claim 4, wherein the second signal is divided by a first signal to produce a quotient, the quotient is further processed by the receive electronics including averaging to produce the coefficient.

6. A metal detector according to claim 3, wherein the coefficient is determined by a negative feedback loop within the receive electronics.

7. A metal detector according to claim 3, wherein the process of the receive electronics including a second synchronous demodulation or sampling of the received signal, the second synchronous demodulation or sampling producing the second signal, is substantially balanced to asynchronous signals in the receive signal.

8. A metal detector according to claim 3, wherein the processing of the received signal including a second synchronous demodulation or sampling of the received signal is substantially balanced to asynchronous signals in the received signal to produce the second signal.

9. A metal detector according to claim 1, wherein the process of the receive electronics including a first synchronous demodulation or sampling of the received signal, the first synchronous demodulation or sampling producing the first signal, is substantially imbalanced to asynchronous signals in the receive signal.

10. A metal detector according to claim 7, wherein the process of the receive electronics including a first synchronous demodulation or sampling of the received signal, the first synchronous demodulation or sampling producing the first signal, is substantially imbalanced to asynchronous signals in the receive signal.

11. A metal detector according to claim 10, wherein the coefficient is selected from a list of pre-programmed coefficients when a reference signal is selected for the first and/or the second synchronous demodulation or sampling.

12. A metal detector according to claim 1, wherein the processing of the received signal including a first synchronous demodulation or sampling of the received signal is substantially imbalanced to asynchronous signals in the received signal to produce the first signal.

13. A metal detector according to claim 8, wherein the processing of the received signal including a first synchronous demodulation or sampling of the received signal is substantially imbalanced to asynchronous signals in the received signal to produce the first signal.

14. A metal detector according to claim 13, wherein the coefficient is selected from a list of pre-programmed coefficients when a reference signal is selected for the first and/or the second synchronous demodulation or sampling.

15. A metal detector according to claim 1, wherein the first signal is substantially independent of a signal due to magnetic soil materials with magnetically permeable resistive components independent of frequency at least up to 100 kHz.

16. A metal detector according to claim 1, wherein an averaging of the received signal produces the said first signal.

17. A metal detector according to claim 16, wherein the averaging is performed by a low-pass filter.
